(19) United States
(12) Patent Application Publication
(10) Pub. No.: US 2024/0345995 A1
(43) Pub. Date: Oct. 17, 2024

(54) APPARATUS, METHOD AND COMPUTER PROGRAM FOR ACCESSING AN APPLICATION SOFTWARE BY A PLURALITY OF USERS

(71) Applicant: Intel Corporation, Santa Clara, CA (US)

(72) Inventor: Juguang ZHENG, Shanghai (CN)

(21) Appl. No.: 18/571,787

(22) PCT Filed: Dec. 9, 2021
(86) PCT No.: PCT/CN2021/136651

§ 371 Date: Dec. 19, 2023

(51) Int. Cl. G06F 16/185; G06F 8/65

(52) U.S. Cl. CPC G06F 16/185; G06F 8/65

(57) ABSTRACT

An apparatus for accessing an application software by a plurality of users is disclosed. The apparatus comprises a physical storage medium. The physical storage medium comprises a lower directory tree and a plurality of user-specific upper directory trees. The apparatus comprises processing circuitry configured to store the application software in the lower directory tree, and, for each of the plurality of users, mount a respective overlay filesystem overlaying the respective user-specific upper directory tree over the lower directory tree. In some examples, the apparatus may be a cloud gaming server. The application software may be a computer game for cloud gaming.

### FIELD

The present disclosure relates to methods, apparatuses, and computer programs for accessing application software (app) by a plurality of users as, for example, in a cloud gaming scenario.

### BACKGROUND

Application software (app or application for short) denotes a computer program designed to help people perform an activity. Depending on the activity for which it was designed, an application can manipulate text, numbers, audio, graphics, and a combination of these elements. Some application packages focus on a single task, such as word processing; others, called integrated software include several applications. A computer game is another example of an application software.

There are computer games for individual users and computer games for a plurality of users. In a cloud gaming scenario, there is huge number of game instances running on a cloud server serving the same game for different users, one game instance for each user. Typically, an individual copy of the game needs to be downloaded and installed on the cloud server for each user instance. This will cost extra network traffic and storage and may hit bandwidth limitation and slow down a connect-to-serve response.

Thus, there may be a demand for lowering network traffic and storage when accessing the same application software (e.g., computer game) on the cloud server by a plurality of users.

### BRIEF DESCRIPTION OF THE FIGURES

Some examples of apparatuses and/or methods will be described in the following by way of example only, and with reference to the accompanying figures, in which

FIG. 1 shows a schematic block diagram of an example apparatus for accessing an application software by a plurality of users;

FIG. 2 shows a schematic block diagram of an example apparatus for accessing an updated application software by a plurality of users;

FIG. 3 shows an example of the proposed concept in the context of Android™ OS;

FIG. 4 shows a concept of an overlay filesystem; and

FIG. 5 shows a flowchart of an example method for accessing an application software by a plurality of users.

### DETAILED DESCRIPTION

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

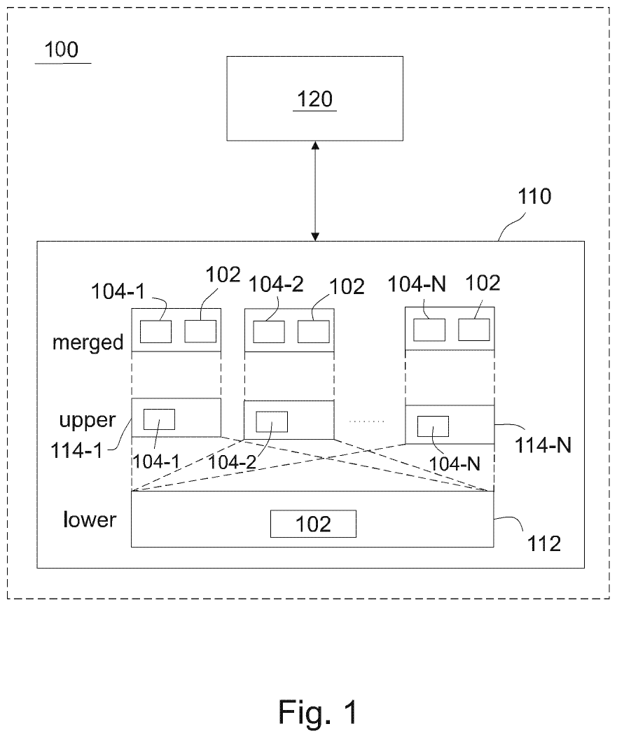

FIG. 1 illustrates a block diagram of an apparatus 100 for accessing application software 102 by a plurality of users in accordance with the present disclosure.

For example, apparatus 100 may comprise a server. A server is computer hardware or software (computer program) that provides functionality for other programs or devices, called “clients”. This architecture is called the client-server model. Servers can provide various functionalities, often called “services”, such as sharing data or computing resources among multiple user clients or performing computation for a user client. A single server can serve multiple user clients, and a single user client can use multiple servers. A client process may run on the same device or may connect over a wired or wireless network to a server on a different device. Examples of servers include database servers, file servers, mail servers, print servers, web servers, game servers, and application servers. A game server (also some-times referred to as a host) is a server which is the authoritative source of events in a multi-player video game. In such an example, the application software 102 may comprise a computer game. The server may transmit enough data about its internal state to allow its connected clients to maintain their own accurate version of the game world for display to play-ers. They may also receive and process each player's input.

The server 100 may be implemented as a cloud server. A cloud server may be regarded a centralized pool of server resources hosted and provisioned over a network-usually the Internet—that can be accessed by multiple users on an on-demand basis. Cloud servers can perform the same functions as traditional physical servers, providing processing power, storage and applications. Cloud servers can be located anywhere in the world and deliver services remotely through a cloud computing environment. In contrast, traditional dedicated server hardware is typically set up on-premises for exclusive use by an organization.

Apparatus or server 100 (which may be a gaming server in some examples) comprises a physical storage medium 110. Physical storage medium 110 may comprise computer components and recording media that are used to retain digital data. Physical storage medium 110 may comprise semiconductor, magnetic, and/or optical storage media. Semiconductor memory may use semiconductor-based integrated circuit (IC) chips to store information. Data may be stored in metal-oxide-semiconductor (MOS) memory cells. A semiconductor memory chip may contain millions of memory cells. Both volatile and non-volatile forms of semiconductor memory exist, the former using standard MOSFETs and the latter using floating-gate MOSFETs. Magnetic storage may use different patterns of magnetization on a magnetically coated surface to store information. Magnetic storage is typically non-volatile. The information may be accessed using one or more read/write heads which may contain one or more recording transducers. A read/write head only covers a part of the surface so that the head or medium or both must be moved relative to another in order to access data. Optical storage, the typical optical disc, may store information in deformities on the surface of a circular disc and may read this information by illuminating the surface with a laser di-ode and observing the reflection. Optical disc storage is typically non-volatile. The deformities may be permanent (read only media), formed once (write once media) or reversible (re-cordable or read/write media).

A filesystem (abbreviated to fs) is a method and data structure that an operating system (OS) uses to control how data is stored and retrieved. There are different kinds of filesystems. Each one has different structure and logic, properties of speed, flexibility, security, size and more. Some file systems have been designed to be used for specific applications. Filesystems can be used on numerous different types of storage devices that use different kinds of media. Hard disk drives have been key storage devices and are projected to remain so for the foreseeable future. Other kinds of media that are used include solid-state drives (SSDs), magnetic tapes, and optical discs. In some cases, a computer's main memory (random-access memory, RAM) may be used to create a temporary filesystem for short-term use. Some filesystems are used on local data storage devices; others provide file access via a network protocol. The filesystem manages access to both the content of files and the metadata about those files.

Filesystems may allocate space in a granular manner, usually multiple physical units on the device. The filesystem is responsible for organizing (computer) files and directories, and keeping track of which areas of the media belong to which file and which are not being used. A computer file is a computer resource for recording data in a computer storage device, primarily identified by its file name. A directory is a filesystem cataloging structure which contains references to other computer files, and possibly other directories.

Physical storage medium 110 of apparatus 100 comprises a filesystem with a lower filesystem (directory tree) 112 and a plurality of user-specific upper filesystems (directory trees) 114-1, 114-2, . . . , 114-N. Thus, physical storage medium 110 may be organized as one or more overlay file systems (OverlayFS). An overlay filesystem is a union mount filesystem combining multiple directories into one that appears to contain their combined contents. It combines multiple different underlying mount points into one, resulting in single directory structure that contains underlying files and sub-directories from all sources.

Apparatus or server 100 further comprises processing circuitry 120 configured to store the application software 102 in the lower filesystem (directory tree) 112 and, for each of the plurality of users, mount a respective overlay filesystem overlaying the respective user-specific upper filesystems (directory trees) 114-1, 114-2, . . . , 114-N over the lower filesystem (directory tree) 112. The lower filesystem (directory tree) 112 may be read-only. The user-specific upper filesystems (directory trees) 114-1, 114-2, . . . , 114-N may be read and write.

Processing circuitry 120 may include electronic circuitry, such as a central processing unit (CPU), that executes instructions comprising a computer program. The CPU may perform basic arithmetic, logic, controlling, and input/output (I/O) operations specified by the instructions in the program. This contrasts with external components such as main memory and I/O circuitry, and specialized processors such as graphics processing units (GPUs). The CPU may run system software designed to provide a platform for other software (for example, computer game). Examples of system software include Operating Systems (OS) like macOS®, Linux®, Android™ and Microsoft Windows®. In some examples, the employed operating system may be a Linux-based operating system and, more specifically, an Android™ operating system.

In some example implementations of apparatus or server 100, processing circuitry 120 may be configured to store user-specific data related to the application software 102 (for example, computer game) for each of the plurality of users in the respective upper filesystems (directory trees) 114-1, 114-2, . . . , 114-N of the overlay file system(s). For example, user-specific data may include user identification data (e.g., name, alias, address, age, sex, etc.), user-specific state(s) of the application software 102 (e.g., current game score, current game level, etc.).

In some example implementations of apparatus or server 100, the application software 102 stored in the lower filesystem (directory tree) 112 may be executable for each of the plurality of users. Combined with the user-specific data stored in the upper filesystems (directory trees) 114-1, 114-2, . . . , 114-N, each of the plurality of users may thus experience his/her own user user-specific application software (for example, computer game) running on the apparatus 100 although the application software 102 may only be stored once (thus saving physical storage medium).

In some example implementations of apparatus 100, processing circuitry 120 may be configured to store an installation or update package of the application software 102 in the lower directory filesystem (directory tree) 112. An installation package may contain all of the information that an OS installer requires to install or uninstall an application or product and to run the setup user interface. In Android™, for example, PackageInstaller offers the ability to install, upgrade, and remove applications on a device. This includes support for apps packaged either as a single “monolithic” APK, or apps packaged as multiple “split” APKs.

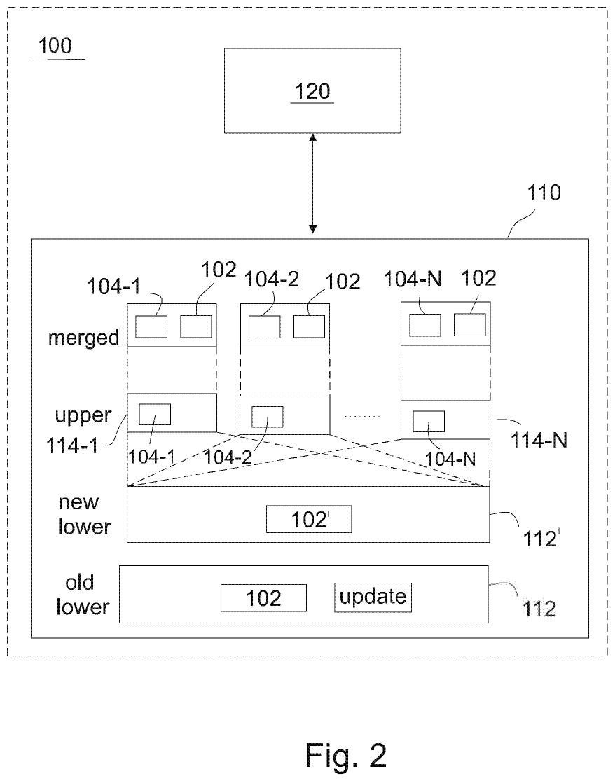

In some example implementations of apparatus 100, as illustrated in FIG. 2, processing circuitry 120 may be configured to, upon an update of the application software 102 stored in the lower filesystem (directory tree) 112, create a new lower filesystem (directory tree) 112′, store the updated application software 102′ in the new lower filesystem (directory tree) 112′, and, for each of the plurality of users, mount a respective new overlay filesystem overlaying the respective user-specific upper filesystem (directory tree) 114-1, 114-2, . . . , 114-N over the newly created lower filesystem (directory tree) 112′. The former lower filesystem (directory tree) 112 may then be deleted.

In some example implementations of apparatus 100, processing circuitry 120 may be configured to execute a user-specific instance of an operating system (OS) for each of the plurality of users. For example, executing the user-specific instance of the operating system may only take place if a respective user is active. Upon inactivity of the respective user, the user-specific instance of the operating system may be deleted, for example. If a respective user is inactive, the respective user-specific data 104-1, 104-2, . . . , 104-N may be saved in the respective upper directory trees 114-1, 114-2, . . . , 114-N, and the whole user-specific instance of the operating system may be deleted. If a respective user is active again, a respective new instance of the operating system may be created, and a respective overlay filesystem may be configured with the respective user-specific data 104-1, 104-2, . . . , 104-N on the respective upper directory trees 114-1, 114-2, . . . , 114-N and the application software in the lower directory tree 112. Activity or inactivity of a user may relate to a user being logged in to or logged out from a cloud service, for example. For another example, activity or inactivity of a user may be related to responsiveness of the user, for example, by means of a time out.

In some example implementations, apparatus or server 100 is configured to execute an instance of the application software 102 for each of the plurality of users and to stream media including video and audio of the respective instance to respective client devices of the users. A user-specific instance of the application software 102 may be executed on a respective user-specific instance of the operating system running on the apparatus or server 100. For example, apparatus or server 100 may be a cloud gaming server configured to stream media including video and audio of the respective game instance to respective client devices of the users.

In an Android™ cloud gaming scenario, for example, there may be huge number of Android™ instances serving the same game for different end users, one Android™/game instance for each user. If the game is not shared for all instances, an own copy for each user needs to be downloaded and installed, which will cost extra network traffic and storage and may also hit bandwidth limitation and slow down a connect-to-serve response.

Most of the top Android™ games nowadays will download and install a data package on the first run and will update from time to time later. Such a data package may be installed into data partition and can conventionally not be shared. It is not easy to figure out the real user data out of the data partition which need to be saved and maintained, which means that extra data may be maintained for safety.

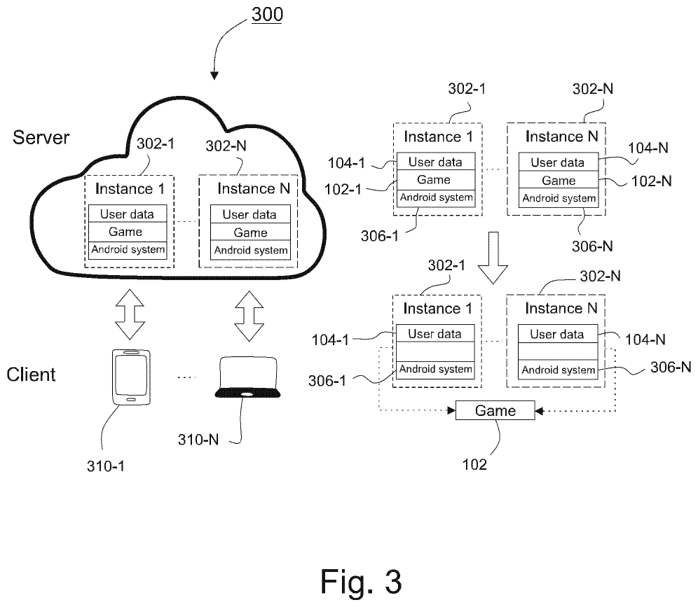

FIG. 3 illustrates an example of a cloud gaming server 300 hosting N user clients 310-1, . . . , 310-N. For each user client 310-1, . . . , 310-N, cloud gaming server 300 runs a respective Android™ instance 302-1, . . . , 302-N including a respective instance of the game 102-1, . . . , 102-N and respective user-specific data 104-1, . . . , 104-N. For example, let us assume N=1000 user-specific Android™ instances running on a cloud gaming server 300. A computer game 102 occupies 2 GB storage and needs 1 GB update package downloaded on the first run. One user-specific Android™ instance 302 can serve one user for a whole day. This re-sults in 1000 GB of network traffic and 2000 GB of storage for all users per day. The proposed solution (illustrated on the bottom right of FIG. 3) can solve these problems via data sharing.

The present disclosure proposes to prepare a data partition 112 with the target game 102 to be installed and updated on first run. The data partition 112 may be used for each Android™ instance 302-1, . . . , 302-N with the above data partition 112 as the base layer via OverlayFS. Once the game 102 needs to be updated, a new base layer 112′ may be prepared and switched to. Everything in the common base layer 112 may be shared among the user-specific Android™ instances 302-1, . . . , 302-N, including the game 102, data package(s), etc. Everything in the upper layer(s) 114-1, . . . , 114-N can be regarded as user-specific data 104-1, . . . , 104-N. The first time Android™ boot may be faster because the data partition has already been prepared via base layer 112.

The present disclosure proposes to use an overlay filesystem (OverlayFS) to achieve less network traffic and less required storage. A final data partition for each Android™ instance 302-1, . . . , 302-N running on the cloud server 300 may comprise
Base layer to be shared as the lowerdir 112, which may be read-only
User data 104 as the upperdir 114, which may be read and write

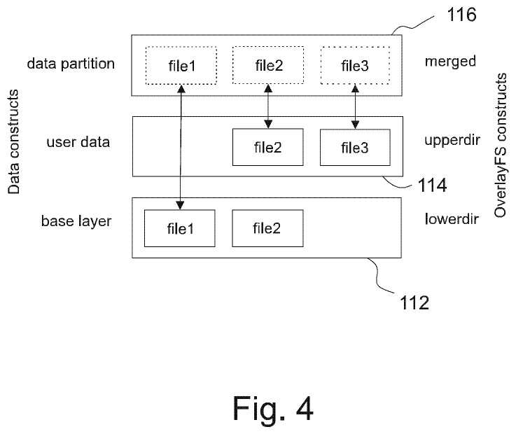

FIG. 4 shows how the OverlayFS of Android™ works.

OverlayFS combines lowerdir 112 and upperdir 114 into a merged directory 116. An overlay filesystem combines two filesystems—an ‘upper’ filesystem 114 and a ‘lower’ filesystem 112. When a name exists in both filesystems, the object in the ‘upper’ filesystem is vis-ible while the object in the ‘lower’ filesystem is either hidden or, in the case of directories, merged with the ‘upper’ object. One may also refer to an upper and lower ‘directory tree’ rather than ‘filesystem’ as it is possible for both directory trees to be in the same filesystem and there is no requirement that the root of a filesystem be given for either upper or lower. A wide range of filesystems supported by Linux can be the lower filesystem (directory tree), but not all filesystems that are mountable by Linux have the features needed for OverlayFS to work. The lower filesystem (directory tree) 112 does not need to be writable. The lower filesystem (directory tree) 112 can even be another OverlayFS. The upper filesystem (directory tree) 112 may be writable.

Overlaying mainly involves directories. If a given name appears in both upper and lower filesystems (directory trees) 114, 112 and refers to a non-directory in either, then the lower object may be hidden—the name may refer only to the upper object. Where both upper and lower objects are directories, a merged directory may be formed. At mount time, the two directories given as mount options “lowerdir” and “upperdir” may be combined into a merged directory:
mount-t overlay overlay-olowerdir=/lower,upperdir=/upper,workdir=/work/merged

The “workdir” needs to be an empty directory on the same filesystem as upperdir. Then whenever a lookup is requested in such a merged directory, the lookup may be performed in each actual directory and the combined result may be cached in the dentry belonging to the overlay filesystem. If both actual lookups find directories, both may be stored and a merged directory may be created, otherwise only one may be stored: the upper if it exists, else the lower. Only the lists of names from directories may be merged. Other content such as metadata and extended attributes may be reported for the upper directory only. These attributes of the lower directory may be hidden.

The following table shows an example of how to setup data partitions/directory structures for two Android™ instances android-1 and android-2:

| Directory | Description |
|---|---|
| data | root folder for the data storage |
| [symbol] android-1 | data partition for instance 1 |
| [symbol] android-2 | data partition for instance 2 |
| [symbol] data | root folder for user data and base layer |
| [symbol] android-1 | user data for instance 1 |
| [symbol] android-2 | user data for instance 2 |
| [symbol] base | base layer |

The base layer (data.data base) 112 may be prepared as follows:
Boot up an Android instance with data.data base as its data partition, all the necessary files may be created by Android at this first boot-up time.
Install the game 102 as usual, e.g., by command “adb install game.apk”, start the game to ensure all the necessary data packages are downloaded and update is done.
Stop Android when done

To setup a data partition for the user-specific Android instances, let us take instance 302-1 (android-1) for example:
Mount OverlayFS at data android-1 as the data partition for Android instance 302-1
data.data android-1 as the upperdir
data.data base as the lowerdir

Now, all the Android instances 302-1, . . . , 302-N may be started with their respective own data partitions OverlayFS at data android-n (n=1, . . . , N) and operate as usual.

To backup the user data, Android™ may be stopped and its user data folder (e.g., data.data android-1) may be copied. To clear the user data (factory reset), Android™ may be stopped and all the files in its user data folder may be deleted. To switch base layer 112 to a new base layer 112′, Android™ may be stopped and all the files in its user data folder may be iterated and removed if an identical or new (comparing the time stamp) one can be found in the new base layer 112′. This may ensure that redundant files are removed and the latest files are used.

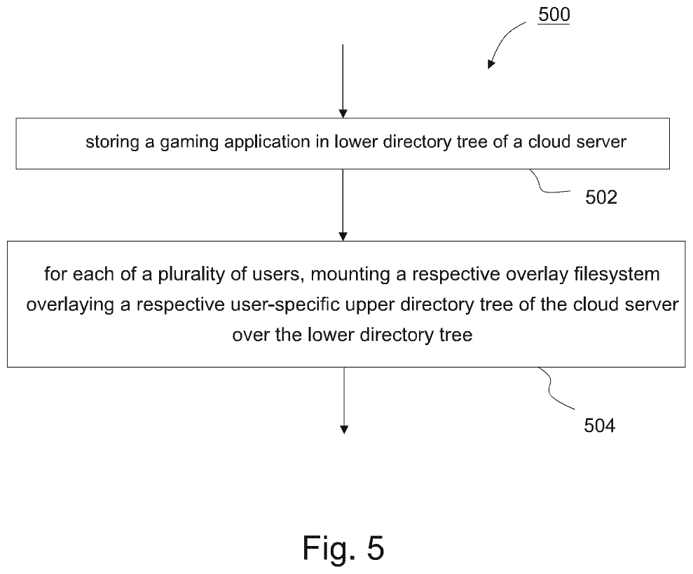

To summarize, FIG. 5 shows a flowchart of a cloud gaming method 500 according to the present disclosure.

Method 500 comprises storing 502 a gaming application 102 in a lower filesystem (directory tree) 112 of a cloud server 100, 300. Method 500 further comprises, for each of a plurality of users, mounting 504 a respective overlay filesystem overlaying a respective user-specific upper filesystem (directory tree) 114-1, . . . , 114-N of the cloud server 100, 300 over the lower filesystem (directory tree) 112.

Method 500 may further comprise storing user-specific data 104-1, . . . , 104-N related to the gaming application 102 for each of the plurality of users in the respective upper filesystem (directory trees) 114-1, . . . , 114-N.

Upon an update of the gaming application 102 stored in the lower filesystem (directory tree) 112, a new lower filesystem (directory tree) 112′ may be created. The updated application software 102′ may be stored in the new lower filesystem (directory tree) 112′. For each of the plurality of users, a respective new overlay filesystem overlaying the respective user-specific upper filesystem (directory tree) 114-1, . . . , 114-N over the new lower filesystem (directory tree) 112′ may be mounted.

A user-specific instance of an operating system (e.g., Android (M) may be executed on the cloud server 100, 300 for each of the plurality of users.

If a user is or gets active, a respective user-specific instance of the operating system may be created. A respective overlay filesystem overlaying the respective user-specific upper filesystem (directory tree) 114-1, . . . , 114-N over the lower filesystem (directory tree) 112 may be configured. A respective user-specific instance of the gaming application 102 stored in the lower filesystem (directory tree) 112 may be executed on the respective user-specific instance of the operating system. If the user is or gets inactive, user-specific data related to the application software may be saved for each of the plurality of users in the respective upper filesystems (directory tree) 114-1, . . . , 114-N. The respective user-specific instance of the operating system may be deleted from the cloud server 100, 300.

An example (e.g. example 1) relates to apparatus for accessing an application software by a plurality of users. The apparatus comprises a physical storage medium. The physical storage medium comprises a lower directory tree and a plurality of user-specific upper directory trees. The apparatus further comprises processing circuitry configured to store the application software in the lower directory tree, and, for each of the plurality of users, mount a respective overlay filesystem overlaying the respective user-specific upper directory tree over the lower directory tree.

Another example (e.g. example 2) relates to a previously described example (e.g. example 1), wherein the processing circuitry is configured to store user-specific data related to the application software for each of the plurality of users in the respective upper directory trees.

Another example (e.g. example 3) relates to a previously described example (e.g. one of the examples 1-2), wherein the application software stored in the lower directory tree is executable for each of the plurality of users.

Another example (e.g. example 4) relates to a previously described example (e.g. one of the examples 1-3), wherein the processing circuitry is configured to store an installation or update package of the application software in the lower directory tree.

Another example (e.g., example 5) relates to a previously described example (e.g. one of the examples 1-4), wherein the processing circuitry is configured to, upon an update of the application software stored in the lower directory tree, create a new lower directory tree, store the updated application software in the new lower directory tree, and, for each of the plurality of users, mount a respective new overlay filesystem overlaying the respective user-specific upper directory tree over the new lower directory tree.

Another example (e.g., example 6) relates to a previously described example (e.g. one of the examples 1-5), wherein the processing circuitry is configured to execute a user-specific instance of an operating system for each of the plurality of users.

Another example (e.g., example 7) relates to a previously described example (e.g. example 6), wherein the processing circuitry is configured to:
if the user is active,
   create a respective user-specific instance of the operating system;
   configure a respective overlay filesystem overlaying the respective user-specific upper directory tree over the lower directory tree;
   execute a respective user-specific instance of the application software stored in the lower directory tree on the respective user-specific instance of the operating system, and if the user is inactive,
   save user-specific data related to the application software for each of the plurality of users in the respective upper directory trees, and
   delete the respective user-specific instance of the operating system.

Another example (e.g., example 8) relates to a previously described example (e.g. one of the examples 6 or 7), wherein the operating system is a Linux-based operating system.

Another example (e.g., example 9) relates to a previously described example (e.g. example 8), wherein the operating system is an Android™ operating system.

Another example (e.g., example 10) relates to a previously described example (e.g. one of the examples 1-9), wherein the physical storage medium comprises non-volatile memory.

Another example (e.g., example 11) relates to a previously described example (e.g. one of the examples 1-10), wherein the apparatus comprises a cloud server.

Another example (e.g., example 12) relates to a previously described example (e.g. examples 11), wherein the cloud server is configured to execute an instance of the application software for each of the plurality of users and to stream media including video and audio of the respective instance to respective client devices of the users.

Another example (e.g., example 13) relates to a previously described example (e.g. one of the examples 1-12), wherein the application software comprises a computer game.

Another example (e.g. example 14) relates to a cloud gaming method. The method comprises storing a gaming application in a lower directory tree of a cloud server, and, for each of a plurality of users, mounting a respective overlay filesystem overlaying a respective user-specific upper directory tree of the cloud server over the lower directory tree.

Another example (e.g., example 15) relates to a previously described example (e.g. example 14), wherein the cloud gaming method further includes storing user-specific data related to the application software for each of the plurality of users in the respective upper directory trees.

Another example (e.g., example 16) relates to a previously described example (e.g. one of the examples 14-15), wherein the cloud gaming method further includes, upon an update of the application software stored in the lower directory tree, creating a new lower directory tree; storing the updated application software in the new lower directory tree; and for each of the plurality of users, mounting a respective new overlay filesystem overlaying the respective user-specific upper directory tree over the new lower directory tree.

Another example (e.g., example 17) relates to a previously described example (e.g. one of the examples 14-16), wherein the cloud gaming method further includes executing a user-specific instance of an operating system for each of the plurality of users.

Another example (e.g., example 18) relates to a previously described example (e.g. one of the examples 14-17), wherein the cloud gaming method further includes:
if the user is active:
   creating a respective user-specific instance of the operating system;
   configuring a respective overlay filesystem overlaying the respective user-specific upper directory tree over the lower directory tree;
   executing a respective user-specific instance of the application software stored in the lower directory tree on the respective user-specific instance of the operating system, and if the user is inactive:
   saving user-specific data related to the application software for each of the plurality of users in the respective upper directory trees, and
   deleting the respective user-specific instance of the operating system.

The aspects and features described in relation to a particular one of the previous examples may also be combined with one or more of the further examples to replace an identical or similar feature of that further example or to additionally introduce the features into the further example.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electro-magnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and subcom-binations with one another. The disclosed methods, apparatuses, and systems are not limited to any specific aspect or feature or combination thereof, nor do the disclosed examples re-quire that any one or more specific advantages be present or problems be solved.

Theories of operation, scientific principles, or other theoretical descriptions presented herein in reference to the apparatuses or methods of this disclosure have been provided for the pur-poses of better understanding and are not intended to be limiting in scope. The apparatuses and methods in the appended claims are not limited to those apparatuses and methods that function in the manner described by such theories of operation.

Although the operations of some of the disclosed methods are described in a particular, se-quential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in con-junction with other methods.

1. An apparatus for accessing an application software by a plurality of users, the apparatus comprising
a physical storage medium comprising
a lower directory tree;
a plurality of user-specific upper directory trees;
processing circuitry configured to
store the application software in the lower directory tree;
for each of the plurality of users, mount a respective overlay filesystem overlaying the respective user-specific upper directory tree over the lower directory tree.

2. The apparatus of claim 1, wherein the processing circuitry is configured to store user-specific data related to the application software for each of the plurality of users in the respective upper directory trees.

3. The apparatus of claim 1, wherein the application software stored in the lower directory tree is executable for each of the plurality of users.

4. The apparatus of claim 1, wherein the processing circuitry is configured to store an installation or update package of the application software in the lower directory tree.

5. The apparatus of claim 1, wherein the processing circuitry is configured to
upon an update of the application software stored in the lower directory tree, create a new lower directory tree;
store the updated application software in the new lower directory tree; and
for each of the plurality of users, mount a respective new overlay filesystem overlaying the respective user-specific upper directory tree over the new lower directory tree.

6. The apparatus of claim 1, wherein the processing circuitry is configured to execute a user-specific instance of an operating system for each of the plurality of users.

7. The apparatus of claim 6, wherein the processing circuitry is configured to
if the user is active,
create a respective user-specific instance of the operating system;
configure a respective overlay filesystem overlaying the respective user-specific upper directory tree over the lower directory tree;
execute a respective user-specific instance of the application software stored in the lower directory tree on the respective user-specific instance of the operating system, and
if the user is inactive,
save user-specific data related to the application software for each of the plurality of users in the respective upper directory trees, and
delete the respective user-specific instance of the operating system.

8. The apparatus of claim 6, wherein the operating system is a Linux-based operating system.

9. The apparatus of claim 8, wherein the operating system is an Android operating system.

10. The apparatus of claim 1, wherein physical storage medium comprises non-volatile memory.

11. The apparatus of claim 1, wherein the apparatus comprises a cloud server.

12. The apparatus of claim 11, wherein the cloud server is configured to execute an instance of the application software for each of the plurality of users and to stream media including video and audio of the respective instance to respective client devices of the users.

13. The apparatus of claim 1, wherein the application software comprises a computer game.

14. A cloud gaming method, the method comprising
storing a gaming application in a lower directory tree of a cloud server; and
for each of a plurality of users, mounting a respective overlay filesystem overlaying a respective user-specific upper directory tree of the cloud server over the lower directory tree.

15. The method of claim 14, further comprising storing user-specific data related to the application software for each of the plurality of users in the respective upper directory trees.

16. The method of claim 14, further comprising
upon an update of the application software stored in the lower directory tree,
creating a new lower directory tree;
storing the updated application software in the new lower directory tree; and
for each of the plurality of users, mounting a respective new overlay filesystem overlaying the respective user-specific upper directory tree over the new lower directory tree.

17. The method of claim 14, further comprising executing a user-specific instance of an operating system for each of the plurality of users.

18. The method of claim 17, comprising
if the user is active,
creating a respective user-specific instance of the operating system;
configuring a respective overlay filesystem overlaying the respective user-specific upper directory tree over the lower directory tree;
executing a respective user-specific instance of the application software stored in the lower directory tree on the respective user-specific instance of the operating system, and
if the user is inactive,
saving user-specific data related to the application software for each of the plurality of users in the respective upper directory trees, and
deleting the respective user-specific instance of the operating system.
